(19) United States
(12) Patent Application Publication
(10) Pub. No.: US 2021/0192531 A1
(43) Pub. Date: Jun. 24, 2021

(54) METHOD FOR AUTOMATICALLY ASSOCIATING A USER OF AN APPLICATION WITH AN ORDER MADE AT A RETAIL LOCATION

(71) Applicant: Billmaster Inc., Brossard (CA)

(72) Inventors: Yannick PEARSON, Brossard (CA); Roger MABILLARD, Saint-Hyacinthe (CA)

(21) Appl. No.: 17/131,413

(22) Filed: Dec. 22, 2020

Related U.S. Application Data
(60) Provisional application No. 62/952,965, filed on Dec. 23, 2019.

(51) Int. Cl. G06Q 20/40; G06Q 50/12; G06Q 20/32; H04W 4/029; G06Q 20/38

(52) U.S. Cl. CPC G06Q 20/40155; G06Q 50/12; G06Q 20/3223; G06Q 20/385; H04W 4/029; G06Q 20/326; G06Q 20/3278; G06Q 20/3224

(57) ABSTRACT

A method for automatically associating a user of an application with an order made at a retail location. A beacon detects the arrival at the retail location of an electronic device having a specific application installed thereon and logged in to a user account and wakes up the application. A remote server is notified that the electronic device is detected to generate a single-use identifier for a session of the user at the retail location and sends the single-use identifier to the electronic device that was detected. A correspondence between the single-use identifier and a given seat or specific location for which orders are managed is received at the retail location computer system (either the one where orders are entered or a distinct device) or using a directional detector, thereby associating said seat or specific location and said orders or session with the user account for eventual payment.

### CROSS-REFERENCE TO RELATED APPLICATIONS

This application claims the priority or benefit of U.S. provisional patent application 62/952,965, filed Dec. 23, 2019, the specification of which is hereby incorporated herein by reference in its entirety.

### BACKGROUND

### (a) Field

The subject matter disclosed generally relates to a system and a method for associating a user of an application with an order made at a retail location, such as a restaurant. More specifically, it relates to a method for detecting a presence of an electronic device in the retail location and identifying the order to be associated therewith.

### (b) Related Prior Art

There are various manners by which e-commerce can be applied to a location where retail services are rendered.

However, prior art systems typically involve many steps or particularities which can be irritating. For example, prior art systems may involve a manual payment at the end of the customer's visit, or require presenting a separate, physical or digital loyalty/rewards program ID. Other sources of irritation may be the need to replace all point-of-sale (POS) devices by custom POS devices.

### SUMMARY

According to an aspect of the invention, there is provided a method for automatically associating a user of an application with an order made at a retail location (e.g., in person), the method comprising the steps of:
detecting, using a beacon, an arrival in the retail location of an electronic device;
by the beacon, waking up the application on the electronic device and logged in to a user account on the electronic device or sending a notification to the electronic device for installing the application and creating the user account;
notifying a remote server that the electronic device is detected, the notifying comprising a user identifier of the user account of the application on the electronic device;
generating a single-use identifier for a session of the user at the retail location and sending the single-use identifier to the electronic device that was detected;
receiving, from a retail location computer system, a correspondence between the single-use identifier and a given seat or specific location for which orders are managed by the retail location computer system, thereby associating said seat or specific location and said orders with the user account;
detecting, using the beacon or another beacon, that the electronic device has left the retail location; and
based on said detecting, charging a payment account registered in the user account corresponding to the electronic device for the orders that were associated to the user account for the session,
wherein said steps are performed regardless of a network connection of the electronic device.

According to an embodiment, the retail location is a restaurant and the seat or specific location is a seat at a restaurant table.

According to an embodiment, the step of receiving the correspondence between the single-use identifier and the given seat or specific location for which orders are managed is performed by the retail location computer system on which orders are entered.

According to an embodiment, the step of receiving the correspondence between the single-use identifier and the given seat or specific location for which orders are managed is performed by an apparatus distinct from the retail location computer system on which orders are entered, the apparatus in communication with the remote server and implementing a point-of-sale helper application for associating said seat or specific location and said orders with the user account.

According to an embodiment, the beacon is a transmitter which can wake-up the application by communicating with an operating system of the electronic device and have the application open and send or receive information if the application is installed.

According to an embodiment, the beacon is an iBeacon™ apparatus.

According to an embodiment, the beacon communicates a detection with the retail location computer system.

According to an embodiment, notifying the remote server that the electronic device is detected is performed by the retail location computer system over a communication network.

According to an embodiment, the electronic device does not communicate with the remote server over the communication network and the step of sending the single-use identifier to the electronic device that was detected is performed through the retail location computer system and the beacon to reach the electronic device.

According to an embodiment, the electronic device is connected to the communication network and the step of sending the single-use identifier to the electronic device that was detected is performed from the remote server through the communication network directly.

According to another aspect of the invention, there is provided a method for automatically associating a user with an order made in person in a retail location, the method comprising the steps of:
detecting, using a beacon, an arrival in the retail location of an electronic device;
by the beacon, waking up the application on the electronic device;
by a directional detector installed for a given table, detecting an angle of arrival of a communication signal with the electronic device;
converting the angle of arrival in an identifier for a seat or specific location;
automatically inputting, into a retail location computer system, an identifier of the user account in association with said seat or specific location for which orders are managed by the retail location computer system, thereby associating said seat or specific location and said orders with the user account;
detecting, using the beacon or another beacon, that the electronic device has left the retail location; and
based on said detecting, charging a payment account registered in the user account corresponding to the electronic device for the orders that were associated to the user account for the session;
wherein said steps are performed regardless of a network connection of the electronic device.

According to an embodiment, the retail location is a restaurant and the seat or specific location is a seat at a restaurant table.

According to an embodiment, the beacon is a transmitter which can wake-up the application by communicating with an operating system of the electronic device and have the application open and send or receive information if the application is installed.

According to an embodiment, the beacon is an iBeacon™ apparatus.

According to an embodiment, the directional detector is a directional Bluetooth™ device.

According to an embodiment, the beacon communicates a detection with the retail location computer system.

According to an embodiment, there is further provided the step of notifying the remote server that the electronic device is detected, performed by the retail location computer system over a communication network.

According to an embodiment, there is further provided the step of sending the identifier, which is a single-use identifier, to the electronic device that was detected wherein the electronic device does not communicate with the remote server over the communication network and the step of sending the identifier is performed through the retail location computer system and the beacon to reach the electronic device.

According to an embodiment, the electronic device is connected to the communication network, further comprising sending the identifier, which is a single-use identifier, to the electronic device that was detected wherein the step of sending the single-use identifier to the electronic device that was detected is performed from the remote server through the communication network directly.

According to an embodiment, the electronic device has a specific application installed thereon and logged in to the user account

### BRIEF DESCRIPTION OF THE DRAWINGS

Further features and advantages of the present disclosure will become apparent from the following detailed description, taken in combination with the appended drawings, in which:

FIG. 1 is a schematic diagram illustrating a system for automatically associating a user of an application with an order made at a retail location, for example in person, according to an embodiment of the invention;

FIG. 2 is a flowchart illustrating a method for automatically associating a user of an application with an order made at a retail location, for example in person, using a personal identification number, according to an embodiment of the invention;

FIG. 3 is a top view illustrating a system for automatically associating a user of an application with a seat in a retail location using directional detector instead of a personal identification number, according to an embodiment of the invention; and

FIG. 4 is a schematic diagram illustrating a system for automatically associating a user of an application with an order made in person in a retail location with an apparatus implementing a point-of-sale (POS) helper application, according to an embodiment of the invention.

It will be noted that throughout the appended drawings, like features are identified by like reference numerals.

### DETAILED DESCRIPTION

There is described a method for automatedly associating (or matching) an order made at a retail location, for example in person, by a customer of a location where retail services are rendered such as a restaurant (or any similar type of venue), generally referred to as a retail location, with the electronic device of that customer, and automatedly making a payment by the customer via an application on the electronic device for that order, which can be made in person, without any manual intervention, as well as (in a non-limiting example) linking that transaction or event with a loyalty or reward program, while avoiding the necessity of custom POS devices.

The method relies on a prior registration of a user with an application, the automatic detection of the arrival of the user at the retail location using the electronic device on which said application is installed, and the identification that an order, which can be made in person or by phone or remotely, is to be associated to the user within the app, to eventually proceed with an automatic payment at the end of the event, as well as other advantages such as order review by the client during the event. Other types of associations can be made from there (e.g., linking with a loyalty or reward program without having to present any card in person).

As described further below, the identification for pairing the user and the order together can be made in different manners, for example using an automatically generated single-use personal identification number (PIN) for pairing via PIN communication. Another example uses a local, in-situ identification device having a directional identification capability (i.e., capable of detecting an angle of arrival of a signal of communication with the electronic device).

As mentioned above, the method makes use of the user having first installed an application on their electronic device 100. The electronic device 100 is mobile, i.e., it is a computing device which is transported by the user at the retail location, such as a smartphone, tablet, phablet, laptop, or any wearable electronic device, such as a smartwatch or glasses, etc., as long as the mobile electronic device to be brought to the location of the retail location can have the application installed thereon and is capable of communicating over the short-range communication protocol used by the method (such as Bluetooth). Therefore, the electronic device for the customer does not have to be a mobile phone, but any electronic device, as long as it has the capability of being wirelessly detected and is carried by or inside the customer (such as implants, wearables, etc.).

Once the user has installed the application on their electronic device 100, the user can connect to their user profile to associate the application on their electronic device to the profile. If no profile has been created first, the user can create the profile. The profile should include basic personal information, comprising payment information, such as a credit card (or any other payment card information), entered into the profile of the application for future use thereof to perform automatic transactions using the registered payment information in the user profile of the application.

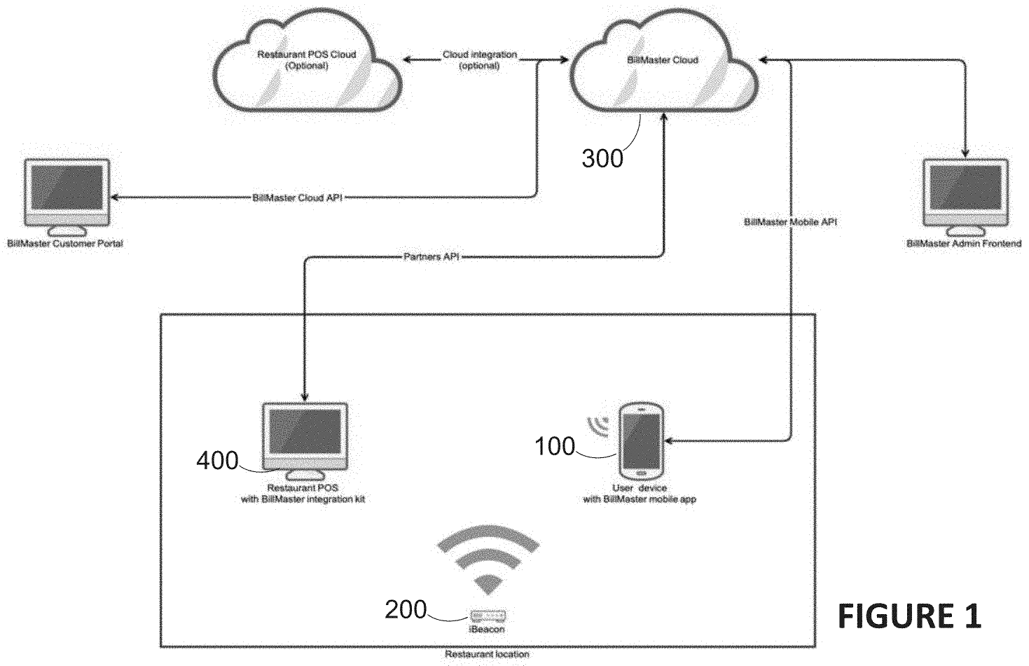

In addition to the user account (i.e., for the customer), there are other types of account, as shown in FIG. 1, such as a administration account for the application managers, a retailer user account (i.e., for the seller, waiter or waitress, hairdresser, or other employee rendering retail services at a specific place or seat in the retail location) which integrates with the point-of-sale system for managing and billing orders in the retail location, and a retailer account (for retail location managers to subscribe to the service and pay their membership). The term “BillMaster” used in the figures is an example of a trademark under which the method can be operated.

In a non-limiting example of implementation, a beacon 200 is installed in the retail location. The beacon 200 is used as a transmitter in the retail location to detect the arrival of an electronic device having the application installed thereon (but not necessarily opened; installed is sufficient even when the application is closed).

According to an embodiment, the beacon 200 is an iBeacon™ or any equivalent thereof, which further acts as a wake-up device and as a bi-directional communicator of location and other data that may be useful. The beacon 200 acts as a transmitter which can wake-up an installed application by communicating with the operating system of the mobile electronic device and have a specific application open and send/receive information if it is installed.

The beacon 200 can be considered to be a mid-range transmitter within the context of the present disclosure, as its range can be within a few meters (and up to a few hundred meters, which would be a long-range, but still applicable to the present disclosure). Typically, the distance between the electronic device 100 and beacon 200, and/or the position using multiple beacons 200, can be determined such that within a given range of distance and within a range of positions, the electronic device 100 can be considered to be at the location of the beacon 200, i.e., inside the retail location, and the application will be awakened.

Although the beacon 200 knows that the electronic device 100 is present, and the application 200 is awakened for the purpose of the user visiting the retail location as a customer (and therefore waiting to make an order soon), there is still no way of knowing which order made in person in the next minutes or hours will correspond to that user (and electronic device 100). The beacon 200 is mainly responsible to notify the device of a region of interest, so that the application is awakened for the purpose of the user visiting the restaurant or any other retail location as a customer (and therefore expected to make an order soon). However, it can also serve as a bi-directional communicator to allow for instant data exchange between the customer electronic device and the system at the retail location, without requiring an active internet connection on the customer device. For example, a PIN (described further below) or any other relevant information could be delivered to the customer device even if that device does not have access to internet, i.e., regardless of the network connection of the electronic device 100; or, equivalently, using a network connection with the beacon 200 to ensure that the electronic device 100 does not use any network connection during the execution of the method.

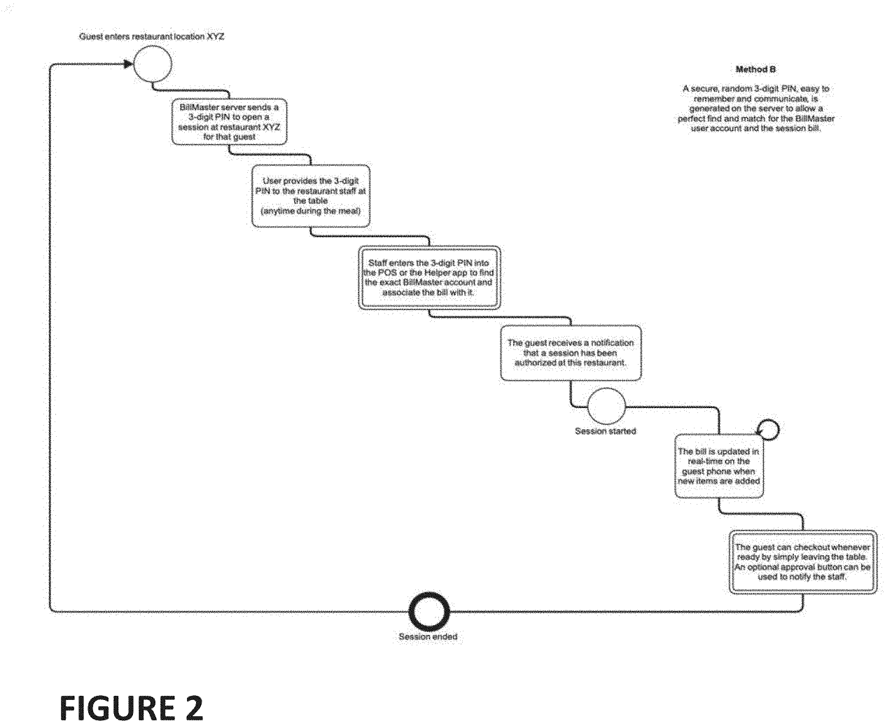

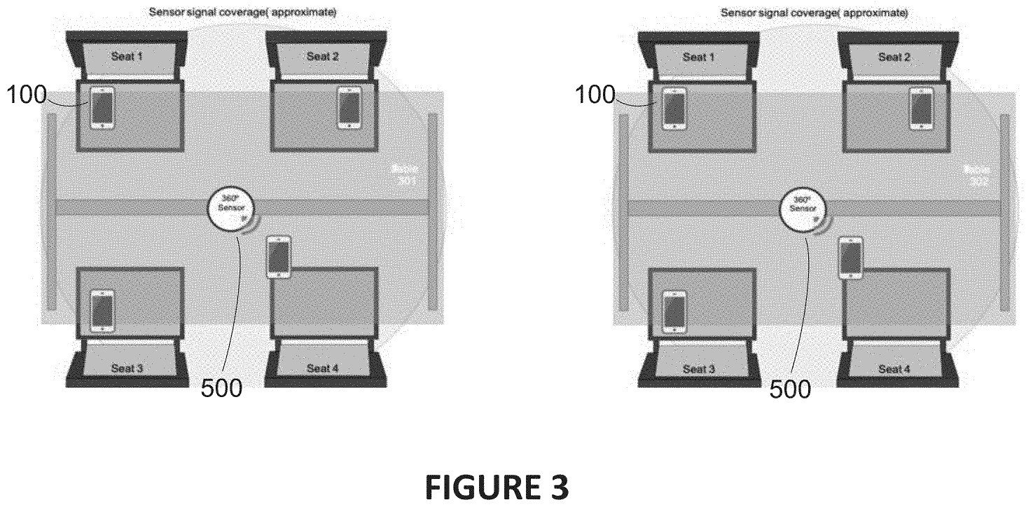

In order to perform this matching/pairing/association between a user of the application and an order made in-person in the retail location (e.g., restaurant, hair salon, etc.), various ways can be contemplated. The disclosure hereby describes in detail two different manners of making this matching/pairing/association, which needs to be done to eventually perform order review by the user and eventually, the automated payment. A first embodiment using a personal identification number (PIN) is described (the system of FIG. 1, plus the method for identification of FIG. 2). Then, a second embodiment using a directional detector in a table setting is described (the system of FIG. 1, plus the directional detector of FIG. 3).

Referring to FIG. 1, there is shown a system which comprises a server 300, typically a remote server or group of servers, (which can be a server hosting the web application, or a cloud implementing the same) connected to the internet, and optionally in direct communication with the beacon 200. When the beacon 200 is detected by the electronic device 100, which wakes up the application installed thereon, there is performed a notification to the server 300 over the internet. The notification can be programmed to be made either by the application on the electronic device 100, or by the beacon 200, directly or via a computer system 400 in the retail location to which it would need to be connected in this particular case.

As shown in FIG. 2, the server 300 then generates a single-use PIN associated to the user, and only for the visit at the retail location which has just started. In other words, the single-use PIN is used for a session.

Afterwards, the server 300 transmits the single-use PIN for the session, i.e., the visit to the user, on the application on the electronic device 100 of that user, either directly or indirectly via the beacon 200 for network redundancy. The PIN can be alphanumeric and should be long enough to be distinctive between all users within the retail location at a given time. For example, three to four characters should be sufficient for most retail locations.

When the PIN is transmitted to the electronic device 100, the application can perform a push notification on the electronic device 100 which is shown automatically to the user (where the user can chose to hide the PIN unless authenticated on the electronic device 100), or which the user can retrieve easily on the application.

When the user gives the order to the employee taking the order at the retail location, for example in person, the user shall also give the PIN that corresponds to their identity and for the order. Optionally, the name (e.g., first name, surname, etc.) of the customer may also be given to ensure greater distinctiveness of the PIN and to make it safer, as the payment is eventually performed automatically.

Now referring to the example in which the retail location is a restaurant, there is provided a computer system 400 on which a restaurant account of the application is installed. Typically, it is a computer terminal located in the restaurant, or a tablet, in which orders are entered for a given seat and also acting as a POS device to prepare and output billing information.

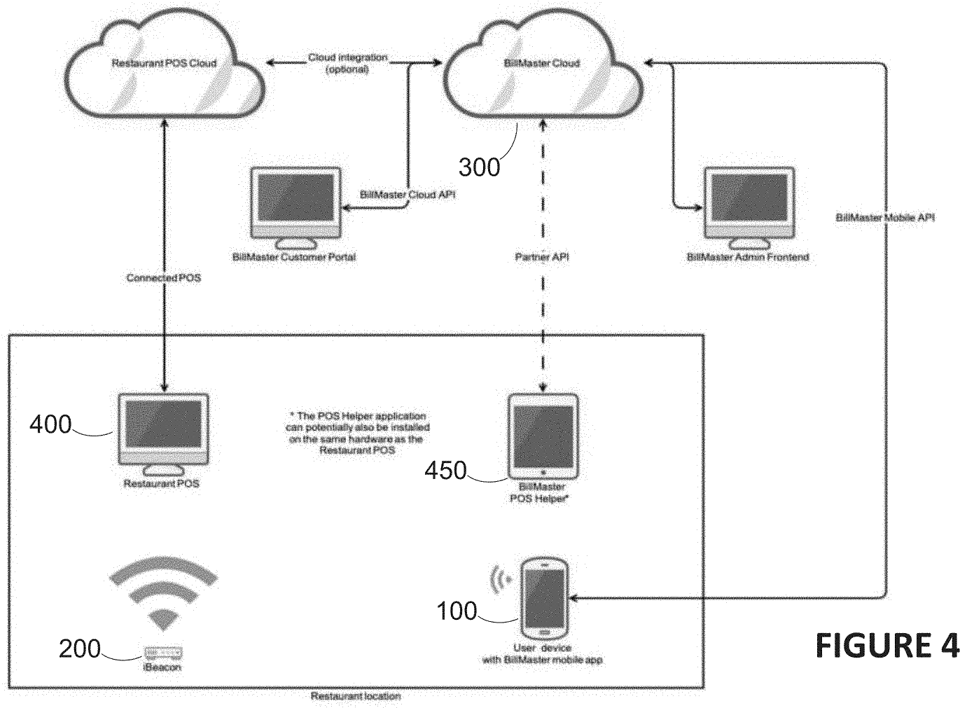

When the waiter or waitress enters the order, obtained orally from the user, into the computer system 400 of the restaurant on which a restaurant account of the application is installed or in the POS Helper installed on an apparatus 450, shown in FIG. 4, i.e., it can be installed on a separate computer system, the PIN should be included for every order for which a PIN was given (and optionally the name that was given too, if applicable), indicating that the user is a customer of the application and that the order being entered in the system should be associated with the profile that corresponds to the PIN in the database on the server 300.

It follows that the restaurant should have the application (either the restaurant version or the POS Helper) installed in their system too. The application mirrors the application of the users. Advantageously, the restaurant-side of the application can be a full suite of services for restaurant management. Alternatively, it can be an add-on which is installed on any compatible one of the most popular software applications for restaurant management.

In the end, regardless of the restaurant management software application, the user interface of such an application on the computer system 400 or POS Helper apparatus 450 should allow the entry, or look up and selection, of the PIN for each order from a customer, and the entry of the PIN should automatically, or upon confirmation on the interface, be transmitted to the server 300.

The server 300 then receives the confirmation that the user has been associated to a customer/seat/order in the restaurant, after validating the PIN of the customer, which is distinctive in the restaurant at that time (and optionally the association of an order with the profile containing pre-entered credit card information is made more secure when combined to the name).

From the moment, the matching/pairing/association is made between a given session of the user of the application and an order made in-person in the restaurant.

In an alternative embodiment, and now referring to FIG. 3, the matching/pairing/association is made without any PIN, and rather takes advantages of an additional device, the directional detector 500, installed in a table setting.

The directional detector 500 acts as a complementary device with respect to the beacon 200. According to an embodiment, the directional detector 500 is a Bluetooth™ transceiver which has a capacity to detect the angle of arrival (AoA) or angle of departure (AoD) of the communication signal with neighboring electronic devices. Typically, the detection is performed within approximately 1 or 2 seconds.

Once an electronic device 100 having the application installed thereon has the application awakened by the beacon 200, it can be more precisely located by the directional detector 500. The directional detector 500 should take advantage that an order at the restaurant is tied to the seat at a given table. The same applies to other types of retail locations, such as a hair salon, a store, etc., where retail services are rendered at a specific seat, place or zone within the retail location and a session is opened at the arrival of the customer, for example, and closed when the customer is finished or leaves.

By providing the directional detector 500 approximately at a center of each table in the restaurant, (or more generally, between different zones within a retail location—more than one directional detector can be used per table or zone) and by ensuring the directional detector 500 can determine an angle of arrival or angle of departure of a communication signal, the directional detector 500 can determine an angle for each electronic device by the table and determine which seat (and therefore which order) is to be associated with a given electronic device 100 detected to be close and having the application installed thereon.

In order to discriminate which electronic device belongs or not to a table (and not from a neighboring table having a similar angle of arrival or departure), the directional detector 500 should have a distance range which is limited to the size of the table and the corresponding seating, typically between 0.5 and 1.5 meter, or about 1 meter for example. Therefore, other electronic devices having a similar angle of arrival or departure but which are to be associated to more distant tables will not be detected and will therefore be excluded by default, as shown in FIG. 3.

In another embodiment, the 360° sensor may be able to detect (to measure) a precise distance of the user electronic devices around the table and thus will not require the distance range of the signal to be limited to the size of the table to eliminate the risk of wrongly associating a customer to a table or checkout counter, allowing potentially for more use-cases. In other words, a directional detector 500 may be used with a larger range and a precision in the order of 50 cm or less to be able to precisely locate a person and associated electronic device 100 within the retail location without requiring one directional detector 500 for each table or each section in the retail location.

The directional detector 500 needs to connect to at least one of 1) the server 300 (e.g., over the internet) or 2) the computer system 400 (using a local communication channel) such that the information it collects can eventually be communicated to the server 300. Alternatively, the directional detector 500 may push the application on each electronic device 100 it detects to communicate, over the internet, with the server 300. Information can be sent to the server which implements the backend of the POS helper app described further below in reference with FIG. 4.

The directional detector 500 should detect each electronic device 100 having the application installed thereon around the table on which the directional detector 500 is installed. The detection should include the angle of arrival or angle of departure, which is converted into a seat identification either by the directional detector 500 itself or by the server 300 or by the computer system 400 of the retail location.

To avoid false seat assignments at the table and therefore errors in the matching/pairing/association process, a combination of software algorithms, calibration and configurations in the directional detector 500, or any other technique, can be used. These techniques may include the use of secondary and tertiary sensors, either internal or external, to reduce the probability of error.

Once a detection at the table and determination of the angle of arrival or angle of departure (or seat, or position at the counter, etc.) is made, the communication is made to the server 300 to collect the information. The detection of the electronic device 100 by the directional detector 500 includes a determination of a user identifier of the application installed thereon, along with the communicated angle of arrival or departure, or seat identifier. In a way or another, the angle of arrival or angle of departure is converted to a seat identifier thanks to a mapping of the retail location or calibration of the directional detector 500 for each table.

In the example of a restaurant, the server 300 eventually sends this information to the computer system 400 in the restaurant, to input the information that identifies the user account or the existence thereof in association with a given seat in the computer system 400 for which orders will be managed by that computer system 400. In other words, there is therefore performed, by the server 300, a matching/pairing/association between a user of the application and a seat identifier in the restaurant, and this association is transmitted automatically into the restaurant management application which runs on the computer system 400. Since the orders are to be entered by the waiter/waitress on a per-seat basis in the restaurant management application which runs on the computer system 400, the user identifier is therefore associated with the orders being made at the restaurant.

Regardless of the manner by which the matching/pairing/association was made, all orders made with respect to a given seat for which a user of the application was matched are entered by the waiter or waitress on the computer system 400, and are attributed to the user of the application which was matched to that seat, for the whole session, i.e., as long as the user is at the restaurant and the orders are ongoing.

From that moment, any information can be shared between the application on the electronic device 100 and the computer system 400, via the server 300 and a local network.

Examples of shared information include the order items added in the computer system 400 for a given user, which that user can consult on the application on their own electronic device 100.

In another example, using AI (artificial intelligence), because the user is known, including his or her preferences, history and habits and any other data pertinent to this moment, the user could be presented with personalized suggestions or content (such as the menu, promotions, etc.) on their electronic device 100, i.e., the server 300 may determine such content and send it to the electronic device 100 for presentation on the user interface thereon.

Other information which can be shared in the other way is the alert which the user can trigger on the application (e.g., mistake in the order, such as a wrong item, or a missing item), and which is transmitted to the computer system 400 in the restaurant such that the waiter or waitress is notified when he or she consults the computer system 400 that something needs to be corrected or addressed (such as an assistance request or reorder) with that particular customer at the seat associated to the application user having triggered the alarm, such that the waiter or waitress can then correct the order in the computer system 400.

When the user of the electronic device 100 leaves the restaurant, or when the waiter or waitress indicates in the restaurant management application which runs on the computer system 400 that the order(s) for the corresponding seat in the restaurant are to be billed, the orders stop for that client and the user of the application can receive a notification that the whole order is complete and will be charged on their credit card. The same applies to other types of locations where retail services are rendered.

Automatic detection of the user leaving the retail location can be made by detecting, using the beacon 100, that the user has left the location. A time buffer can be included to ensure that leaving is not confused with a temporary exit of the person.

Optionally, the user can be given a time period (buffer) to review the ordered items for approval. By approving the bill, or by waiting a predetermined period of time without having received a notification of disapproval through the application, the order will be billed using the pre-entered credit card (or payment card) information in the user profile. Implicit approval after a time buffer, with the possibility of notifying the retail location for any inaccuracy, can be preferred over an approval button in the application, as it ensures that the transaction is performed automatically, without any intervention from either the waiter or the application user.

As an alternative method for payment, the user could also supply an amount of money into their account, which is then used for subsequently billed orders.

According to another embodiment, an amount is reserved to the credit card immediately after the matching/pairing/association happens. This way, the retail location ensures that their bill will be paid and that there are sufficient funds for what the client is ordering. If the customer exceeds the previously reserved amount by making an addition to the order for his or her seat, an additional amount is reserved again prior to processing the order, and otherwise the order is not executed.

Now referring to FIG. 4, there is shown an architecture for point-of-sale (POS) Helper app which can be used advantageously 1) to speed up the integration with any POS system already in-use at the retail location, and 2) to provide a better and extended experience to the retail staff when the method described above is used in that retail location.

FIG. 4 shows a network diagram for the system implementing the integration with a retail location using the POS Helper app. The Helper app could potentially be installed on existing hardware at the retail location as long as it is compatible with the operating system.

FIG. 4 shows an architecture similar to FIG. 1. It shows that an apparatus 450 implements the POS helper application, which can be a tablet computer or a smartphone, or any other tabletop or laptop computer. It can be implemented on the computer system 400 in the retail location.

The apparatus 450 that implements the POS helper application is used by the staff at the retail location to aid in the association of a seat (or specific location) with a user and his or her session. Therefore, the bill association can be done using the POS helper app that is either installed on a separate device (laptop computer, tabletop computer, tablet computer, smartphone, wearable device, etc.) or on the same hardware as the existing POS, but as a separate application (distinct from the application implementing the method above and distinct from the restaurant or retail location management application). This separate POS helper app then provides the two advantages mentioned above. The apparatus 450 that implements the POS helper application should communicate with the server 300, as described above in reference with FIG. 1.

It should be noted that the embodiments of the method described above include an identification process (detection of an electronic device and association with a user account and then association with a session) which can be used in cases other than seating at a restaurant. For example, it can include cases in which the seat is replaced by a specific location of the user, for example standing in a line within the retail location or in the immediate vicinity thereof. For example, it can be applied for takeout and curbside pickup orders either made online or at the restaurant, as well as reservations (not just restaurants) in other types of retail locations including personal services. The identification process would be made using a single or dual-factor authentication, using a combination of digital ID, biometrics data and AI.

It should be noted that the method uses computers to identify people and associated transactions during a session, and therefore, the personal electronic device of the people entering the retail location is essential to carry out the method. The device which actively detects them, i.e., the beacon, is also essential to carry out the method as it is the device which performs detection of arrival and departure of the person through their electronic device being detected. Also, the network and remote servers connected through the network are also essential to associate sessions with users and perform transactions.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for automatically associating a user of an application with an order made at a retail location, the method comprising the steps of:
detecting, using a beacon, an arrival in the retail location of an electronic device;
by the beacon, waking up the application on the electronic device and logged in to a user account on the electronic device or sending a notification to the electronic device for installing the application and creating the user account;
notifying a remote server that the electronic device is detected, the notifying comprising a user identifier of the user account of the application on the electronic device;
generating a single-use identifier for a session of the user at the retail location and sending the single-use identifier to the electronic device that was detected;
receiving, from a retail location computer system, a correspondence between the single-use identifier and a given seat or specific location for which orders are managed by the retail location computer system, thereby associating said seat or specific location and said orders with the user account;
detecting, using the beacon or another beacon, that the electronic device has left the retail location; and
based on said detecting, charging a payment account registered in the user account corresponding to the electronic device for the orders that were associated to the user account for the session,
wherein said steps are performed regardless of a network connection of the electronic device.

2. The method of claim 1, wherein the retail location is a restaurant and the seat or specific location is a seat at a restaurant table.

3. The method of claim 1, wherein the step of receiving the correspondence between the single-use identifier and the given seat or specific location for which orders are managed is performed by the retail location computer system on which orders are entered.

4. The method of claim 1, wherein the step of receiving the correspondence between the single-use identifier and the given seat or specific location for which orders are managed is performed by an apparatus distinct from the retail location computer system on which orders are entered, the apparatus in communication with the remote server and implementing a point-of-sale helper application for associating said seat or specific location and said orders with the user account.

5. The method of claim 1, wherein the beacon is a transmitter which can wake-up the application by communicating with an operating system of the electronic device and have the application open and send or receive information if the application is installed.

6. The method of claim 5, wherein the beacon is an iBeacon™ apparatus.

7. The method of claim 1, wherein the beacon communicates a detection with the retail location computer system.

8. The method of claim 7, wherein notifying the remote server that the electronic device is detected is performed by the retail location computer system over a communication network.

9. The method of claim 8, wherein the electronic device does not communicate with the remote server over the communication network and the step of sending the single-use identifier to the electronic device that was detected is performed through the retail location computer system and the beacon to reach the electronic device.

10. The method of claim 8, wherein the electronic device is connected to the communication network and the step of sending the single-use identifier to the electronic device that was detected is performed from the remote server through the communication network directly.

11. A method for automatically associating a user with an order made at a retail location, the method comprising the steps of:
detecting, using a beacon, an arrival in the retail location of an electronic device;
by the beacon, waking up the application on the electronic device;
by a directional detector installed for a given table, detecting an angle of arrival or angle of departure of a communication signal with the electronic device;
converting the angle of arrival or angle of departure in an identifier for a seat or specific location;
automatically inputting, into a retail location computer system, an identifier of a user account in association with said seat or specific location for which orders are managed by the retail location computer system, thereby associating said seat or specific location and said orders with the user account;
detecting, using the beacon or another beacon, that the electronic device has left the retail location; and
based on said detecting, charging a payment account registered in the user account corresponding to the electronic device for the orders that were associated to the user account for the session;
wherein said steps are performed regardless of a network connection of the electronic device.

12. The method of claim 11, wherein the retail location is a restaurant and the seat or specific location is a seat at a restaurant table.

13. The method of claim 12, wherein the beacon is a transmitter which can wake-up the application by communicating with an operating system of the electronic device and have the application open and send or receive information if the application is installed.

14. The method of claim 13, wherein the beacon is an iBeacon™ apparatus.

15. The method of claim 11, wherein the directional detector is a directional Bluetooth™ device.

16. The method of claim 11, wherein the beacon communicates a detection with the retail location computer system.

17. The method of claim 16, further comprising notifying the remote server that the electronic device is detected, performed by the retail location computer system over a communication network.

18. The method of claim 17, further comprising sending the identifier, which is a single-use identifier, to the electronic device that was detected wherein the electronic device does not communicate with the remote server over the communication network and the step of sending the identifier is performed through the retail location computer system and the beacon to reach the electronic device.

19. The method of claim 17, wherein the electronic device is connected to the communication network, further comprising sending the identifier, which is a single-use identifier, to the electronic device that was detected wherein the step of sending the single-use identifier to the electronic device that was detected is performed from the remote server through the communication network directly.

20. The method of claim 11, wherein the electronic device has a specific application installed thereon and logged in to the user account.
